(19) United States
(12) Patent Application Publication
(10) Pub. No.: US 2011/0191335 A1
(43) Pub. Date: Aug. 4, 2011

(54) METHOD AND SYSTEM FOR CONDUCTING LEGAL RESEARCH USING CLUSTERING ANALYTICS

(75) Inventors: David J. MILLER, Dayton, OH (US); David Alan Bayliss, Delray Beach, FL (US); Zachary W. Bennett, Centerville, OH (US); Harry R. Silver, Shaker Heights, OH (US)

(73) Assignee: LexisNexis Risk Data Management Inc., Boca Raton, FL (US)

(21) Appl. No.: 12/696,371

(22) Filed: Jan. 29, 2010

(51) Int. Cl. G06F 17/30; G06N 5/02

(52) U.S. Cl. 707/728; 707/738; 706/54; 707/780; 707/E17.047; 707/755; 707/E17.014

(57) ABSTRACT

Disclosed herein are various exemplary systems and methods for conducting legal research using clustering analytics. A system for building relationships between passages, the system comprising a passage generation module configured to generate passages from one or more case law documents, an annotation module configured to annotate the passages based on one or more attributes, and a clustering module configured to build relationship clusters between the passages based on the one or more attributes.

### RELATED APPLICATIONS

This application is related to U.S. patent application Ser. No. 10/357,418, entitled “Method And System For Processing and Linking Data Records,” filed Feb. 4, 2003, and U.S. patent application Ser. No. 10/357,481, entitled “Method And System For Linking and Delinking Data Records,” filed Feb. 4, 2003, both of which are hereby incorporated by reference in their entireties.

Also incorporated by reference in their entireties are:
U.S. patent application Ser. No. 12/188,742 entitled “Database systems and methods for linking records and entity representations with sufficiently high confidence” to Bayliss;
U.S. patent application Ser. No. 12/429,337 entitled “Statistical record linkage calibration for multi token fields without the need for human interaction” to Bayliss;
U.S. patent application Ser. No. 12/429,350 entitled “Automated selection of generic blocking criteria” to Bayliss;
U.S. patent application Ser. No. 12/429,361 entitled “Automated detection of null field values and effectively null field values” to Bayliss;
U.S. patent application Ser. No. 12/429,370 entitled “Statistical record linkage calibration for interdependent fields without the need for human interaction” to Bayliss;
U.S. patent application Ser. No. 12/429,377 entitled “Statistical record linkage calibration for reflexive, symmetric and transitive distance measures at the field and field value levels without the need for human interaction” to Bayliss;
U.S. patent application Ser. No. 12/429,382 entitled “Statistical record linkage calibration at the field and field value levels without the need for human interaction” to Bayliss;
U.S. patent application Ser. No. 12/429,394 entitled “Statistical record linkage calibration for reflexive and symmetric distance measures at the field and field value levels without the need for human interaction” to Bayliss;
U.S. patent application Ser. No. 12/429,403 entitled “Adaptive clustering of records and entity representations” to Bayliss;
U.S. patent application Ser. No. 12/429,408 entitled “Automated calibration of negative field weighting without the need for human interaction” to Bayliss;
U.S. patent application Ser. No. 12/496,861 entitled “Statistical measure and calibration of search criteria where one or both of the search criteria and database is incomplete” to Bayliss;
U.S. patent application Ser. No. 12/496,876 entitled “A system and method for identifying entity representations based on a search query using field match templates” to Bayliss;
U.S. patent application Ser. No. 12/496,888 entitled “Batch entity representation identification using field match templates” to Bayliss;
U.S. patent application Ser. No. 12/496,899 entitled “System for and method of partitioning match templates” to Bayliss;
U.S. patent application Ser. No. 12/496,915 entitled “Statistical measure and calibration of internally inconsistent search criteria where one or both of the search criteria and database is incomplete” to Bayliss;
U.S. patent application Ser. No. 12/496,929 entitled “Statistical measure and calibration of reflexive, symmetric and transitive fuzzy search criteria where one or both of the search criteria and database is incomplete” to Bayliss;
U.S. patent application Ser. No. 12/496,948 entitled “Entity representation identification using entity representation level information” to Bayliss; and
U.S. patent application Ser. No. 12/496,965 entitled “Technique for recycling match weight calculations” to Bayliss.

These applications are referred to herein as the “Second Generation Patents And Applications.”

### BACKGROUND

One technique for using data to achieve a useful purpose is record linkage or matching. Record linkage generally is a process for linking, matching or associating data records and typically is used to provide insight and effective analysis of data contained in data records. Data records, which may include one or more discrete data fields containing data, may be derived from one or more sources and may be linked or matched, for example, based on: identifying data (e.g., social security number, tax number, employee number, telephone number, etc.); exact matching based on entity identification; and statistical matching based on one or more similar characteristics (e.g., name, geography, product type, sales data, age, gender, occupation, license data, etc.) shared by or in common with records of one or more entities.

Record linkage or matching involves accessing data records, such as commonly stored in a database or data warehouse, and performing user definable operations on accessed data records to harvest or assemble data sets for presentation to and use by an end user. As a prelude or adjunct to record linkage, processes such as editing, removing contradictory data, cleansing, de-duping (i.e., reducing or eliminating duplicate records), and imputing (i.e., filling in missing or erroneous data or data fields) are performed on the data records to better analyze and present the data for consumption and use by an end user. This has been referred to as statistical data editing (SDE). One category of statistical processes that has been discussed for use in performing SDE is sometimes referred to as “classical probabilistic record linkage” theory and in large part derives from the works of I. P. Fellegi, D. Holt and A. Sunter. Such models generally employ algorithms that are applied against data tables. More widely adopted general models, such as if-then-else rules, for SDE have been difficult to implement in computer code and difficult to modify or update. This typically requires developers to create custom software to implement complex if-then-else and other rules. These traditional processes may be error-prone, costly, inflexible, time-intensive and generally requires customized software for each solution.

Although record linkage may be conducted by unaided human efforts, such efforts, even for the most elementary linkage operation, are time intensive and impractical for record sets or collections of even modest size. Also, such activity may be considered tedious and unappealing to workers and would be prohibitively expensive from an operations standpoint. Accordingly, computers are increasingly utilized to process and link records. However, the extensive amount of data collected that must be processed has outpaced the ability of even computerized record linkage systems to efficiently and quickly process such large volumes of data to satisfy the needs of users. Speed of processing data records and generating useful results is critical in most applications. The veracity of data records may be important in some applications. There is a constant balance between the speed of processing and compiling data, the level of veracity of composite data records linked and presented, and the flexibility of the processing system for user customizable searching and reporting. Even with applications where speed of results generation is not critical, it is generally desired. Most present day record linkage systems are OLAP, OLTP, RDBMS based systems using query languages such as SQL.

There are many drawbacks associated with this technology, which has not effectively met or balanced the competing interests of speed, veracity and flexibility. Such systems are limited as to the complexity of the processes, such as deterministic, probabilistic and other statistical processes, that may be effectively performed on databases or data farms or warehouses.

In addition, application of such techniques for legal research in particular is limited. Case law documents contain multiple independent discussions on disparate topics. Because key aspects of a researcher's topic may be contained in different parts of a case, with a variety of other topics mixed in, it may be difficult to search through such a complex collection of documents to arrive at useful results. Legal research generally needs to be complete. Attorneys generally desire to find the cases that support a client's claim and need to prepare arguments for cases that do not support the claim. Accordingly, an efficient and comprehensive analytic may be useful in identifying key components of a case, e.g., facts and points of law discussions, and extract these to form single topic passages useful for legal research.

### BRIEF DESCRIPTION OF DRAWINGS

The purpose and advantages of the present invention will be apparent to those of ordinary skill in the art from the following detailed description in conjunction with the appended drawings in which like reference characters are used to indicate like elements, and in which:

FIG. 1 is a graphical illustration of an exemplary case law document containing mixed content in accordance with at least one embodiment of the present invention.

FIG. 2 is a graph illustrating an exemplary cluster-based mapping for legal research in accordance with at least one embodiment.

FIGS. 3A-3B are graphical illustrations of an exemplary hardware components for conducting legal research in accordance with at least one embodiment of the present invention.

FIG. 4 is a flow chart illustrating an exemplary process for conducting legal research using clustering analytics in accordance with at least one embodiment of the present invention.

FIG. 5 is a flow chart illustrating an exemplary process for conducting legal research using clustering analytics in accordance with at least one embodiment of the present invention.

### DETAILED DESCRIPTION OF THE PRESENT INVENTION

The following description is intended to convey a thorough understanding of the present invention by providing a number of specific embodiments and details involving processing data to determine links between entity references to a particular entity and associations among entities. It is understood, however, that the present invention is not limited to these specific embodiments and details, which are exemplary only. It is further understood that one possessing ordinary skill in the art, in light of known systems and methods, would appreciate the use of the present invention for its intended purposes and benefits in any number of alternative embodiments, depending upon specific design and other needs.

At least one embodiment of the present invention may be employed in systems designed to provide, for example, legal research. The results of the system query operations may be presented to users in any of a number of useful ways, such as in a report that may be printed or displayed on a computer. The system may include user interface tools, such as graphical user interfaces (GUIs) and the like, to help users structure a preferred search, presentation, and report.

The system of the present invention may also provide a batch search process to accelerate searches of the types listed above on large numbers of entity references, such as when performing, for example, a search on one or more legal topics or points of law.

In one embodiment, the system may be accessible over a network, such as in an online fashion over the Internet. The system may involve the downloading of an application or applet at a local user or client side computer or terminal to establish or maintain a communications link with a central server to access or invoke the query builder process of the system and to initiate or accomplish a query search. After, prior to or as part of the query process, the user may be required to complete an order or request input and the system may generate an order or request confirmation. In one manner, the confirmation may be displayed on the user's screen and may summarize the options that have been selected for the batch job or other query request and the maximum possible charge for the selected options. After reviewing the confirmation summary and before final commitment to the service and associated charge, the user may then select an “Authorize Order” button or the like to submit the request and finalize the order. The system may then present the user with an order acceptance screen. After the batch process is executed and the results generated, the results may be forwarded to the user in any of a number of desired manners, such as via an email address, street address, secure site upload, or other acceptable methods.

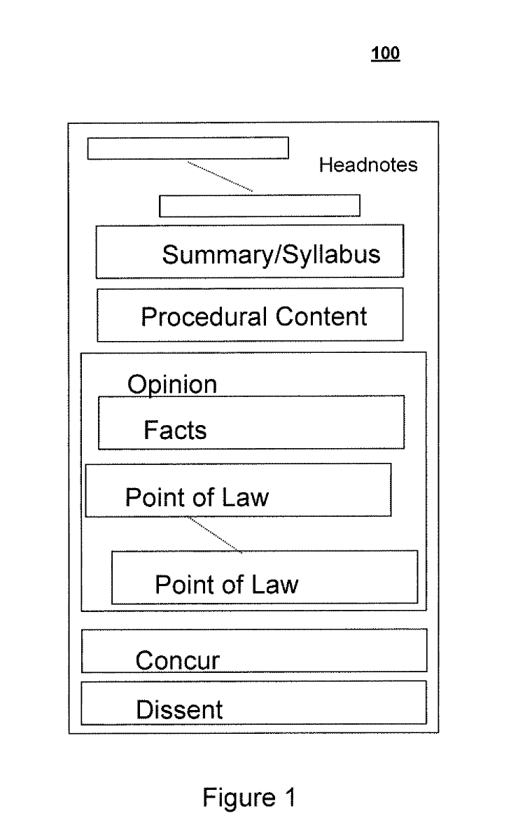

FIG. 1 is a graphical illustration of an exemplary case law document containing mixed content 100 in accordance with at least one embodiment of the present invention. The case law document 100 may include many items of information, such as procedural information, factual information, and discussions of multiple points of law. As depicted in FIG. 1, the case law document may include one or more headnotes, summaries, syllabi, procedural content, opinions, facts, dicta, points of law, concurring opinions, dissenting opinion, etc. Furthermore, case law documents that are related might not necessarily share the same terminology. As discussed above, for at least these reasons, a collection of case law documents may be a difficult to search through.

One way to render a case law document more manageable for searching is to break down the case law document into one or more “passages” or “hub passages.” A case law document typically contains a multitude of topics. For example, there may be one to ten or one to thirty issues that are argued in a particular case. A case law document typically begins with a factual discussion before delving into the point of law related to the facts. Oftentimes, although loosely connected by the facts, the legal discussions are almost completely disparate between the different points of law. As a result, a case law document may be broken up into individual “passages,” where each passage may discuss or contain a single point, concept, or pattern (e.g., a point of law, fact pattern, etc.). A “hub passage” may refer to a single topic passage that cites one or more landmark citations as well as several other citations. Breaking up a case law document into passages may make a case law document more manageable for searching. A hub passage may be a passage that provides links to variety of other cases that define a particular point, concept, or pattern. By breaking a case law document in a variety of passages or hub passages, key components of a case, e.g., facts, points of law, similar discussions, etc., may be identified, extracted, and useful for legal research.

There are several goals in legal research. One goal may be to sift through a great number of case law documents and identify which ones are related, relevant, and applicable to a researcher. This process of research may be particularly helpful at the beginning of research project (e.g., to quickly learn about or be familiar with a particular issue or point of law) and at the end of a research project (e.g., to verify relative completeness of research of a particular topic or point of law). According to one or more embodiments, performing analysis on a large collection of case law aids the researcher's process in the following ways: (1) provide a fast starting point for research by quickly locating a key passage of text that provides a current and robust discussion of a particular point of law; or (2) provide an analysis of a research result for verifying completeness of case law research (e.g., set in the form of a Table of Authorities (TOA) that indicates the relative completeness of the TOA and indicates other case law documents that could be important).

Beginning a legal research project may be intimidating and difficult, especially if the researcher is unfamiliar with the legal landscape of a particular point of law. Embodiments of the present invention may assist a researcher find the most recent decision on the desired topic that includes a detailed discussion of the topic, where the discussion may be a passage from the case, not the whole case. The passage may also cite numerous other cases that define the law—a hub passage. Such passages may be similar to sections appearing in secondary legal resources, such as American Law Reports (ALR). However, it should be appreciated that these passages may have key distinctions, e.g., they are written by judges and identifiable by a computer (e.g., software). The discussion in the passage may also be dicta, not holding, and can come from a variety of portions within a case law document, such as the opinion or concurring or dissenting portions.

Verifying completeness of legal research may also be a challenge. For example, after a brief is prepared using a variety of sources and case law documents, it may be desirable for determine whether the cited case law in the brief is “good law” or to identify any important case law documents left out of the brief. Typically, a researcher may find it difficult to know when he or she has found and reviewed enough cases to consider his or her research complete. The output of the user's research tasks may include a written description of the facts and point of law, a list of cases reviewed, or a list of cases to include in a motion or brief. Embodiments of the present invention may provide a tool that accepts the user's current research as input and then verifies completeness by: (1) Identifying new cases relevant to her research that she has not reviewed; or (2) Providing graphic feedback of the percent of relevant cases she has reviewed and included in her work product.

Embodiments of the present invention may provide one or more high performance computing clusters for identifying hub passages within case law. Once identified, the system may cluster these hub passages, along with other passages, in a manner that will present the results to a user in any one of several ways, such as a searchable database of passages, a set of content recommendations to supplement the user's existing results, etc.

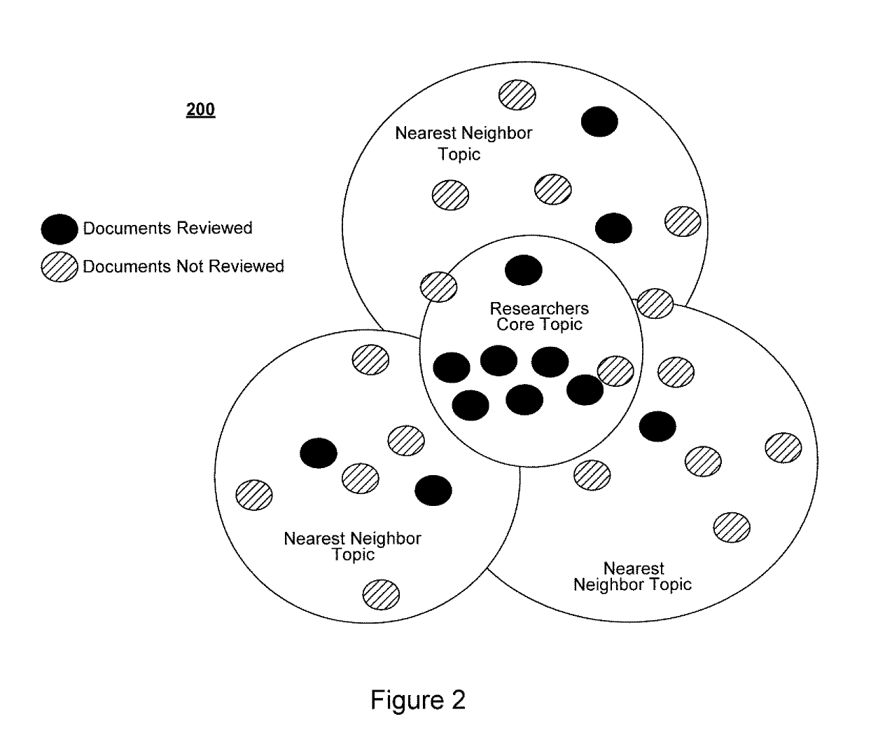

FIG. 2 is a graph illustrating an exemplary cluster-based mapping for legal research 200 in accordance with at least one embodiment. The cluster-based mapping 200 may represent a possible “Completeness Check” interface for a researcher who is finishing up his or her research. The mapping 200 may show the researchers core topics and one or more nearby neighbor topics. The mapping 200 may also show which case law documents he or she has reviewed. In this representation, it appears that there is at least one case law document that the researcher did not review or consider in the research. Accordingly, embodiments of the present invention may provide a valuable tool for legal research.

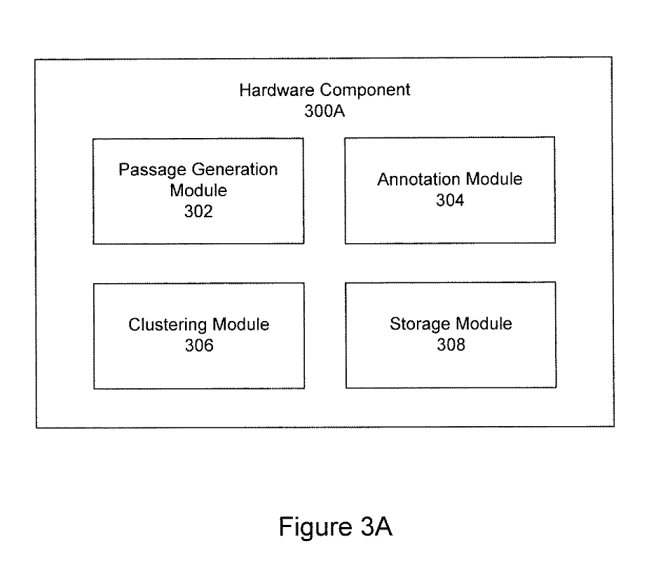

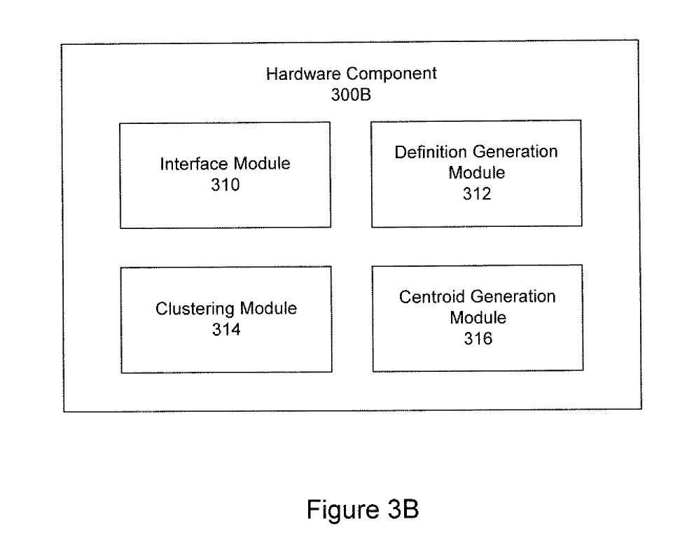

FIGS. 3A-3B are graphical illustrations of an exemplary hardware components for conducting legal research in accordance with at least one embodiment of the present invention. FIG. 3A is a graphical illustration of an exemplary hardware component 300A for conducting legal research in accordance with at least one embodiment of the present invention. Hardware component 300A may include a passage generation module 302, an annotation module 304, a clustering module 306, and a storage module 308. FIG. 3B is a graphical illustration of an exemplary hardware component 300B for conducting legal research in accordance with at least one embodiment of the present invention. Hardware component 300B may include an interface module 310, a definition generation module 312, a clustering module 314, and a centroid generation module 316.

It should be appreciated that the hardware components or modules for providing and performing the legal analytics for legal research as described herein may be implemented in one or more systems, components, processes, or methods described in the Second Generation Patents And Applications, which are herein incorporated by reference in their entireties. The Second Generation Patents And Applications include:
U.S. patent application Ser. No. 12/188,742 entitled “Database systems and methods for linking records and entity representations with sufficiently high confidence” to Bayliss;
U.S. patent application Ser. No. 12/429,337 entitled “Statistical record linkage calibration for multi token fields without the need for human interaction” to Bayliss;
U.S. patent application Ser. No. 12/429,350 entitled “Automated selection of generic blocking criteria” to Bayliss;
U.S. patent application Ser. No. 12/429,361 entitled “Automated detection of null field values and effectively null field values” to Bayliss;
U.S. patent application Ser. No. 12/429,370 entitled “Statistical record linkage calibration for interdependent fields without the need for human interaction” to Bayliss;
U.S. patent application Ser. No. 12/429,377 entitled “Statistical record linkage calibration for reflexive, symmetric and transitive distance measures at the field and field value levels without the need for human interaction” to Bayliss;
U.S. patent application Ser. No. 12/429,382 entitled “Statistical record linkage calibration at the field and field value levels without the need for human interaction” to Bayliss;
U.S. patent application Ser. No. 12/429,394 entitled “Statistical record linkage calibration for reflexive and symmetric distance measures at the field and field value levels without the need for human interaction” to Bayliss;
U.S. patent application Ser. No. 12/429,403 entitled “Adaptive clustering of records and entity representations” to Bayliss;
U.S. patent application Ser. No. 12/429,408 entitled “Automated calibration of negative field weighting without the need for human interaction” to Bayliss;
U.S. patent application Ser. No. 12/496,861 entitled “Statistical measure and calibration of search criteria where one or both of the search criteria and database is incomplete” to Bayliss;
U.S. patent application Ser. No. 12/496,876 entitled “A system and method for identifying entity representations based on a search query using field match templates” to Bayliss;
U.S. patent application Ser. No. 12/496,888 entitled “Batch entity representation identification using field match templates” to Bayliss;
U.S. patent application Ser. No. 12/496,899 entitled “System for and method of partitioning match templates” to Bayliss;
U.S. patent application Ser. No. 12/496,915 entitled “Statistical measure and calibration of internally inconsistent search criteria where one or both of the search criteria and database is incomplete” to Bayliss;
U.S. patent application Ser. No. 12/496,929 entitled “Statistical measure and calibration of reflexive, symmetric and transitive fuzzy search criteria where one or both of the search criteria and database is incomplete” to Bayliss;
U.S. patent application Ser. No. 12/496,948 entitled “Entity representation identification using entity representation level information” to Bayliss; and
U.S. patent application Ser. No. 12/496,965 entitled “Technique for recycling match weight calculations” to Bayliss.

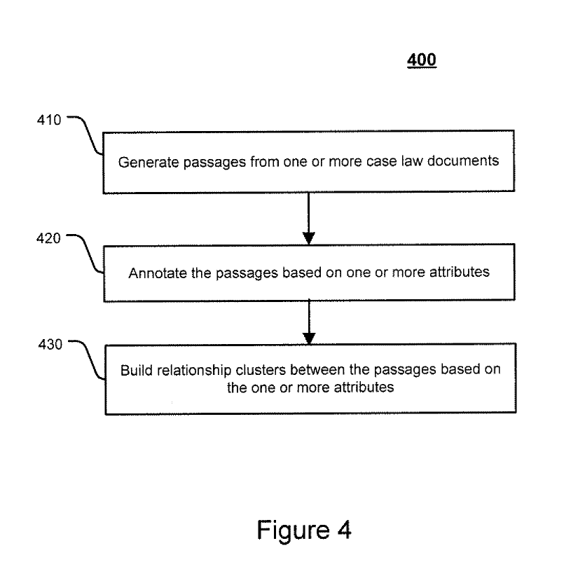

FIG. 4 is a flow chart illustrating an exemplary method for conducting legal research using clustering analytics 400, or more specifically, for building relationships between passages, in accordance with at least one embodiment of the present invention. The exemplary method 400 is provided by way of example, as there are a variety of ways to carry out methods disclosed herein. The method 400 shown in FIG. 4 may be executed or otherwise performed by one or a combination of various systems. The method 400 is described below as carried out by at least component 300A in FIG. 3A, by way of example, and various elements of component 300 are referenced in explaining the exemplary method of FIG. 4. Each block shown in FIG. 4 represents one or more processes, methods, or subroutines carried in the exemplary method 400. A computer readable medium comprising code to perform the acts of the method 400 may also be provided. Referring to FIG. 4, the exemplary method 400 may begin at block 410.

At block 410, a passage generation module may generate passages from one or more case law documents. Each passage may be based on at least one of a single point of law and a fact pattern. For example, the passage generation module may generate passages by identifying and extracting one or more key words and phrases from the one or more case law documents, identifying and extracting one or more paragraphs that describe the facts of the case, identifying and extracting one or more paragraphs associated with a single point of law based on topic shift technology, associating the paragraphs that describe facts of the case with paragraphs associated with the single point of law, and generating a passage that has both the relevant facts and the legal discussion for a single point of law. Topic shift technology is discussed in greater detail by Marti A. Hearst in “TextTiling: Segmenting Text into Multi-Paragraph Subtopic Passages,” Computational Linguistics, MIT Press, Cambridge, Mass., Vol. 23, Issue 1, March 1997, and U.S. Pat. No. 6,772,149, entitled “System and Method for Identifying Facts and Legal Discussion in Court Case Law Documents” to Morelock et al., both of which are incorporated herein by reference in their entireties.

It should be appreciated that the passage may be searchable. In addition, the search logic may be customized by special weighting for facts versus legal concepts or present the most recent passage first from a set of passages with similar relevance. Other various customizable features may also be provided.

At block 420, an annotation module configured to annotate the passages based on one or more attributes. Annotating the passages may provide a way to describe the passage. The one or more attributes may comprise at least one core term. Core terms may be keywords or phrases that represent the meaning of a passage. These may also include, but not limited to, citations to statutes and cases as well as other types classification information. Also, core terms may include cites to cases, statutes, or other material. It should be appreciated that core terms, as used and described, is further discussed in U.S. Patent Application No. 2007/0130100, entitled “Method and System for Linking Documents with Multiple Topics to Related Documents” to Miller, which is herein incorporated by reference in its entirety.

Although citing references are not core terms since they are external to a passage or case law document, citing references may also be used similarly. For example, if a law review article cites three (3) different cases, these cases may share and have in common that particular citing reference (i.e., the law review article), and therefore, three cases may be presumed to have some degree of similarity. If the citation from the law review (or case or treatise) is further qualified to a specific passage (e.g., using either a jump page or the words proximate to the citation reference), it should be appreciated that a reasonably strong similarity measure between the passages may also be provided.

The attributes that describe the passage may be the key words within the passage that are legal discussion words, key words about the passage that have to do with the fact patterns, statutes cited by that passage, cases cited by that passage, or other legal taxonomy or classifications. In other words, the one or more attributes provide a legal taxonomy or classification for the passage. Accordingly, any documents that might cite that specific passage or at least cite the case that contained the passage may be identified.

It should be appreciated that landmark citations or other sources may be identified or annotated. Use and implementation of identification and annotation of landmark cases and/or other sources is described in U.S. Patent Application No. 2006/0041608, entitled “Landmark Case Identification System and Method” to Miller, which is herein incorporated by reference in its entirety. Other customizable annotations or identifiers may also be used, such as frequency of citation, etc.

At block 430, a clustering module configured to build relationship clusters between the passages based on the one or more attributes. Building relationships and clusters may be important because different words may be used to describe the same point of law. Therefore, using and classifying passages within a particular taxonomy helps to identify all relevant passages.

In some embodiments, the clustering module may determine relationship information clusters by identifying all passages for a particular jurisdiction or subset, and grouping all passages in the particular jurisdiction or subset that all discuss a similar point of law. Grouping the passages may comprise clustering combined passages that have legal issue discussion and specific fact, clustering point of law discussion without facts, then sub-clustering based on facts, clustering the passages based on facts, then sub-clustering based on legal discussion, using multiple clustering spaces and combining the results, or a combination thereof.

It should be appreciated that at least one database may also be provided and configured to store the passages and relationship clusters for future retrieval.

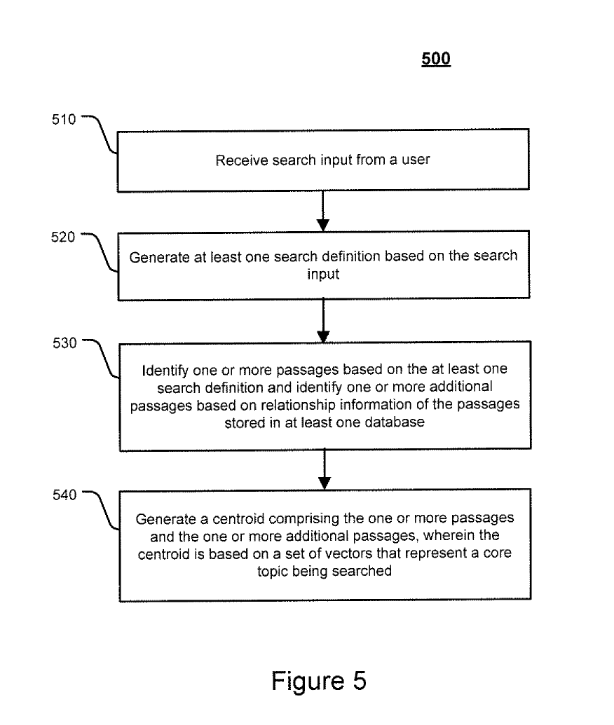

FIG. 5 is a flow chart illustrating an exemplary method for conducting legal research using clustering analytics 500, or more specifically, for building relationships between passages, in accordance with at least one embodiment of the present invention. The exemplary method 500 is provided by way of example, as there are a variety of ways to carry out methods disclosed herein. The method 500 shown in FIG. 5 may be executed or otherwise performed by one or a combination of various systems. The method 500 is described below as carried out by at least component 300B in FIG. 3B, by way of example, and various elements of component 300 are referenced in explaining the exemplary method of FIG. 5. Each block shown in FIG. 5 represents one or more processes, methods, or subroutines carried in the exemplary method 500. A computer readable medium comprising code to perform the acts of the method 500 may also be provided. Referring to FIG. 5, the exemplary method 500 may begin at block 510.

At block 510, a user interface may be configured to receive search input from a user. The search input may comprise key words or phrases from at least one manual entry, document, list of citations, list of statutes, and passages. At block 520, a definition generator may be configured to generate at least one search definition based on the search input.

At block 530, a clustering module configured to identify one or more passages based on the at least one search definition and identify one or more additional passages based on relationship information of the passages stored in at least one database. Finding a document via search may yield one set of results. But finding other documents classified within the same or nearby cluster may also yield relevant results. This is particular important because, as described above, some relevant results may not contain identical search input provided by a user to describe a similar or same point of law.

In some embodiments, the relationship information may be based on clusters created by identifying all passages for a particular jurisdiction or subset, and grouping all passages in the particular jurisdiction or subset that all discuss a similar point of law. Grouping the passages may comprise at least one of clustering combined passages that have legal issue discussion and specific fact, clustering point of law discussion without facts, then sub-clustering based on facts, clustering the passages based on facts, then sub-clustering based on legal discussion, using multiple clustering spaces and combining the results, or a combination thereof.

Dynamic clustering may also be provided. For example, the clustering module may be configured to provide dynamic clustering by identifying point-of-law passages within a query cite list that are relevant to the query topic, returning a set of the relevance-ranked passages not contained in the set of point-of-law passages, and clustering the point-of-law passages and query search passages to create a cluster set suitable for graphic display and topic shift analysis.

It should be appreciated that dynamic clustering may also be provided and performed according to one or more embodiments and processes described in the Second Generation Patents And Applications identified above, which are herein incorporated by reference in their entireties.

At block 540, a centroid generation module may be configured to generate a centroid comprising the one or more passages and the one or more additional passages, wherein the centroid is based on a set of vectors that represents a core topic being searched. It should be appreciated that the set of vectors is a characteristic of the centroid to allow similar passages to be identified and presented. A centroid may be a theoretical point in the “middle” of a cluster defined by the most common attributes among the passages of the cluster. The centroid may not necessarily coincide with an actual passage. However, it should be appreciated that there may be one or more passages closest to the centroid. These passages may be referred to as “centroid passages.”

It should also be appreciated that a ranking module may be configured to relevance-rank the one or more passages and the one or more additional passages using based on the centroid. A presentation module may also be provided and configured to present the one or more passages and the one or more additional passages in order of relevance to the user.

Relevance ranking may be the process of ordering passages or documents based upon their statistical similarity to a query, another document, a cluster centroid, or other object that shares one or more common attributes. Word-based algorithms used for ranking documents may include the vector space model and probabilistic model as described in Gerald Salton's “Automatic Text Processing: The Transformation, Analysis, and Retrieval of Information by Computer,” Addison-Wesley Longman Publishing Co., Inc., Boston, Mass., 1989, which is incorporated herein in its entirety.

The statistical similarity measure may also be used to determine linking for the purposes of generating clusters. When difference attribute types are used in combinations, such as core terms, case law citations, statute citations, citing documents, taxonomy classifications, etc., different measures may be used for each attribute type and different weighting may be applied to the attribute type measures as they may be combined to create a single overall measure.

It should be appreciated that centroid-generation and relevance-ranking may also be provided and performed according to one or more embodiments and processes described in the Second Generation Patents And Applications identified above, which are herein incorporated by reference in their entireties.

In some embodiments, a mapping of the researcher's work product into the clustered passage space and select most relevant clusters may be presented. In other embodiments, a list of unseen documents may be presented. In yet other embodiments, a map the documents by similarity to researcher's topic and similarity to nearest neighbor topics may also be presented.

It should be appreciated that by using passages, rather than whole documents, embodiments of the present invention may provide several notable advantages. A user's text and citation mix may be used to identify passages within the research set that may be clustered. Organization and searchability may be optimized with passages since passages may be single topic and cluster better than multiple topic case law documents.

Other embodiments, uses, and advantages of the present invention will be apparent to those skilled in the art from consideration of the specification and practice of the present invention disclosed herein. The specification and drawings should be considered exemplary only, and the scope of the present invention is accordingly intended to be limited only by the following claims and equivalents thereof.

What is claimed is:

1. A system for building relationships between passages, the system comprising:
a passage generation module configured to generate passages from one or more case law documents;
an annotation module configured to annotate the passages based on one or more attributes; and
a clustering module configured to build relationship clusters between the passages based on the one or more attributes.

2. The system of claim 1, further comprising at least one database configured to store the passages and relationship clusters for future retrieval.

3. The system of claim 1, wherein each passage is based on at least one of a single point of law and a fact pattern.

4. The system of claim 1, wherein the passage is a hub passage.

5. The system of claim 1, wherein the passage generation module generates passages by:
identifying and extracting one or more key words and phrases from the one or more case law documents;
identifying and extracting one or more paragraphs that describe the facts of the case;
identifying and extracting one or more paragraphs associated with a single point of law based on topic shift technology; and
associating the paragraphs that describe facts of the case with paragraphs associated with the single point of law; and
generating a passage that has both the relevant facts and the legal discussion for a single point of law.

6. The system of claim 1, wherein the one or more attributes comprises at least one core term, wherein the core term comprises at least one keyword, key phrase, citation to a statute, case, or reference, and classification information.

7. The system of claim 1, wherein the clustering module determines relationship information clusters by:
identifying all passages for a particular jurisdiction or subset; and
grouping all passages in the particular jurisdiction or subset that all discuss a similar point of law, wherein grouping the passages comprises at least one of:
clustering combined passages that have legal issue discussion and specific fact, clustering point of law discussion without facts, then sub-clustering based on facts,
clustering the passages based on facts, then sub-clustering based on legal discussion, and
using multiple clustering spaces and combining the results.

8. A method for building relationships between passages, the method comprising:
generating passages from one or more case law documents;
annotating the passages based on one or more attributes; and
determining relationship information between the passages based on the one or more attributes.

9. The method of claim 8, further comprising storing the passages and relationship clusters in at least one data storage unit for future retrieval.

10. The method of claim 8, wherein each passage is based on at least one of a single point of law and a fact pattern.

11. The method of claim 8, wherein the passage is a hub passage.

12. The method of claim 8, wherein generating passages comprises:
identifying and extracting one or more key words and phrases from the one or more case law documents;
identifying and extracting one or more paragraphs that describe the facts of the case;
identifying and extracting one or more paragraphs associated with a single point of law based on topic shift technology; and
associating the paragraphs that describe facts of the case with paragraphs associated with the single point of law; and
generating a passage that has both the relevant facts and the legal discussion for a single point of law.

13. The method of claim 8, wherein the one or more attributes comprises at least one core term, wherein the core term comprises at least one keyword, key phrase, citation to a statute, case, or reference, and classification information.

14. The method of claim 8, wherein determining relationship information comprising building clusters by:
identifying all passages for a particular jurisdiction or subset; and
grouping all passages in the particular jurisdiction or subset that all discuss a similar point of law, wherein grouping the passages comprises at least one of:
clustering combined passages that have legal issue discussion and specific fact, clustering point of law discussion without facts, then sub-clustering based on facts,
clustering the passages based on facts, then sub-clustering based on legal discussion, and
using multiple clustering spaces and combining the results.

15. A computer readable medium comprising a set of executable instructions for performing the acts of method in claim 8.

16. A system for legal research using passages, the system comprising:
a user interface configured to receive search input from a user;
a definition generator configured to generate at least one search definition based on the search input;
a clustering module configured to identify one or more passages based on the at least one search definition and identify one or more additional passages based on relationship information of the passages stored in at least one database;

17. The system of claim 16, further comprising a centroid generation module configured to generate a centroid associated with the one or more passages and the one or more additional passages, wherein the centroid is based on a set of vectors that represents a core topic being searched and represents one or more common attributes among the one more passages and the one or more additional passages.

18. The system of claim 17, further comprising:
a ranking module configured to relevance-rank the one or more passages and the one or more additional passages using based on the centroid; and
a presentation module configured to present the one or more passages and the one or more additional passages in order of relevance to the user.

19. The system of claim 16, wherein the relationship information is based on clusters created by:
identifying all passages for a particular jurisdiction or subset; and
grouping all passages in the particular jurisdiction or subset that all discuss a similar point of law, wherein grouping the passages comprises at least one of:
clustering combined passages that have legal issue discussion and specific fact, clustering point of law discussion without facts, then sub-clustering based on facts,
clustering the passages based on facts, then sub-clustering based on legal discussion, and
using multiple clustering spaces and combining the results.

20. The system of claim 16, wherein the clustering module is configured to provide dynamic clustering by:
identifying point-of-law passages within a query cite list that are relevant to the query topic;
returning a set of the relevance-ranked passages not contained in the set of point-of-law passages; and
clustering the point-of-law passages and query search passages to create a cluster set suitable for graphic display and topic shift analysis.

21. The system of claim 16, wherein the search input comprises key words or phrases from at least one manual entry, document, list of citations, list of statutes, and passages.

22. A method for legal research using passages, the method comprising:
receiving search input from a user;
generating at least one search definition based on the search input;
identifying one or more passages based on the at least one search definition; and
identifying one or more additional passages based on relationship information of the passages stored in at least one database.

23. The method of claim 22, further comprising generating a centroid associated with the one or more passages and the one or more additional passages, wherein the centroid is based on a set of vectors that represents a core topic being searched and represents one or more common attributes among the one more passages and the one or more additional passages.

24. The method of claim 23, further comprising:
relevance-ranking the one or more passages and the one or more additional passages using based on the centroid; and
presenting the one or more passages and the one or more additional passages in order of relevance to the user.

25. The method of claim 22, wherein the relationship information is based on clusters created by:
identifying all passages for a particular jurisdiction or subset; and
grouping all passages in the particular jurisdiction or subset that all discuss a similar point of law, wherein grouping the passages comprises at least one of:
clustering combined passages that have legal issue discussion and specific fact, clustering point of law discussion without facts, then sub-clustering based on facts,
clustering the passages based on facts, then sub-clustering based on legal discussion, and
using multiple clustering spaces and combining the results.

26. The method of claim 22, further comprising dynamic clustering based on:
identifying point-of-law passages within a query cite list that are relevant to the query topic;
returning a set of the relevance-ranked passages not contained in the set of point-of-law passages; and
clustering the point-of-law passages and query search passages to create a cluster set suitable for graphic display and topic shift analysis.

27. The system of claim 22, wherein the search input comprises key words or phrases from at least one manual entry, document, list of citations, list of statutes, and passages.

28. A computer readable medium comprising a set of executable instructions for performing the acts of method in claim 22.
